(19) United States
(12) Patent Application Publication
(10) Pub. No.: US 2026/0221863 A1
(43) Pub. Date: Jul. 30, 2026

(54) CELL BYPASS FOR VARIABLE FREQUENCY DRIVES

(71) Applicant: Innomotics GmbH, 90441 Nürnberg (DE)

(72) Inventor: JASON WAGGEL, Connellsville, PA (US)

(73) Assignee: Innomotics GmbH, 90441 Nürnberg (DE)

(21) Appl. No.: 19/151,921

(22) PCT Filed: Feb. 9, 2023
(86) PCT No.: PCT/US2023/012659

§ 371 Date: Jul. 29, 2025

(51) Int. Cl. H02M 1/00; H02M 1/32; H02P 27/14

(52) U.S. Cl. CPC H02M 1/007; H02M 1/32; H02P 27/14; H02P 2201/13

(57) ABSTRACT

A drive system includes a power circuit (600, 700, 800) with a plurality of power cells supplying power to output phases (A, B, C), each output phase including a phase group of series-connected power cells, a voltage source power supply, and a bypass mechanism (650, 750, 850) comprising spare power cells and bypass contactors, wherein the phase groups of the power circuit are connected at a point of common coupling, and wherein a spare power cell is installed at the point of common coupling.

### BACKGROUND

### 1. Field

Aspects of the present disclosure relate to a variable frequency drive, also referred to as VFD, that powers an electric motor, driving a load such as pump, compressor, fan, or reciprocating compressor system etc. Throughout the specification, the terms “drive”, “drive system”, “multilevel power converter”, “converter”, “power supply” and “variable frequency drive (VFD)” can be used interchangeably.

### 2. Description of the Related Art

Medium voltage variable frequency drives, such as for example multilevel power converters are used in the applications of medium voltage alternating current (AC) drives, flexible AC transmission systems (FACTS), and High Voltage DC (HVDC) transmission systems, because single power semiconductor devices cannot handle high voltage. Multilevel converters typically include a plurality of power cells for each phase, each power cell including an inverter circuit having semiconductor switches that are capable of altering the voltage output of the individual cells. One example of a multilevel power converter is a cascaded H-bridge converter system having a plurality of H-bridge cells as described for example in U.S. Pat. No. 5,625,545 to Hammond, the content of which is herein incorporated by reference in its entirety.

Another example of a multilevel power converter is a modular multilevel converter system having a plurality of M2C or M2LC subsystems. The M2C or M2LC subsystems are herein also referred to as M2C or M2LC cells or simply as power cells. The M2LC topology is popular in medium to high voltage applications since it provides several advantages over other topologies, for example simple process of scaling the number of output voltage levels by a linear addition of identical cells, capacitor free direct current (DC)-link, continuous link currents, reduced voltage rating of the switches and redundant switching operations. However, the M2C or M2LC cells are not independently supplied from isolated voltage sources or secondary windings. The cells are typically supplied from a common DC link via for example AC/DC rectifier systems or batteries, wherein for a given cell, the amount of energy processed at the two terminals depends on the amount of energy supplied to the cell by the link it is connected to and to some extent the ability of the cell to store and release energy.

Additionally, various methods of implementing cell bypass have been employed, wherein redundant cells are added to the M2CL subsystems. The methods require the redundant cells to provide N+1 redundancy, N+2 redundancy, etc. by adding one additional cell row (rank), two additional cell rows, etc. to both the positive and negative arms of the power cells.

### SUMMARY

Briefly described, aspects of the present disclosure relate to a power circuit of a drive system including cell bypass, the drive system being configured for example as a medium voltage variable frequency drive.

More specifically, a drive system comprises a power circuit comprising a plurality of power cells supplying power to output phases, each output phase comprising a phase group of series-connected power cells, a voltage source power supply, and a bypass mechanism comprising spare power cells and bypass contactors, wherein the phase groups of the power circuit are connected at a point of common coupling, and wherein a spare power cell is installed at the point of common coupling.

### BRIEF DESCRIPTION OF THE DRAWINGS

FIG. 1 illustrates a schematic of a basic configuration of a modular multilevel converter system in accordance with an exemplary embodiment described herein.

FIG. 2 illustrates a known two-level configuration of an M2LC subsystem having two terminals in accordance with an exemplary embodiment described herein.

FIG. 3 illustrates a known three-level configuration of an M2LC subsystem having two terminals in accordance with an exemplary embodiment described herein.

FIG. 4 illustrates another known three-level configuration of an M2LC subsystem having two terminals in accordance with an exemplary embodiment described herein.

FIG. 5 illustrates a schematic diagram of a known basic configuration of a cascaded H-bridge converter system in accordance with an exemplary embodiment described herein.

FIG. 6 illustrates a schematic diagram of a first embodiment of a modular multilevel converter system having a plurality of M2C or M2LC subsystems and including cell bypass in accordance with an exemplary embodiment of the present disclosure.

FIG. 7 illustrates a schematic diagram of a second embodiment of a modular multilevel converter system having a plurality of M2C or M2LC subsystems and including cell bypass in accordance with an exemplary embodiment of the present disclosure.

FIG. 8 illustrates a schematic diagram of an embodiment of a cascaded H-bridge converter system including cell bypass in accordance with an exemplary embodiment of the present disclosure.

### DETAILED DESCRIPTION

To facilitate an understanding of embodiments, principles, and features of the present disclosure, they are explained hereinafter with reference to implementation in illustrative embodiments. In particular, they are described in the context of being a drive system, such as a medium voltage (MV) variable frequency drive including multi-cell power supplies including modular multilevel converter systems and cascaded H-bridge converter systems. Like reference numerals represent like elements throughout.

As used herein, a “medium voltage” is a voltage of greater than about 690V and less than about 69 kV, and a “low voltage” is a voltage less than about 690V. A person of ordinary skill in the art will understand that other voltage levels may be specified as “medium” voltage and “low voltage”. For example, in some embodiments, a “medium voltage” may be a voltage between about 3 kV and about 69 kV, and a “low voltage” may be less than about 3 kV.

The components and materials described hereinafter as making up the various embodiments are intended to be illustrative and not restrictive. Many suitable components and materials that would perform the same or a similar function as the materials described herein are intended to be embraced within the scope of embodiments of the present invention.

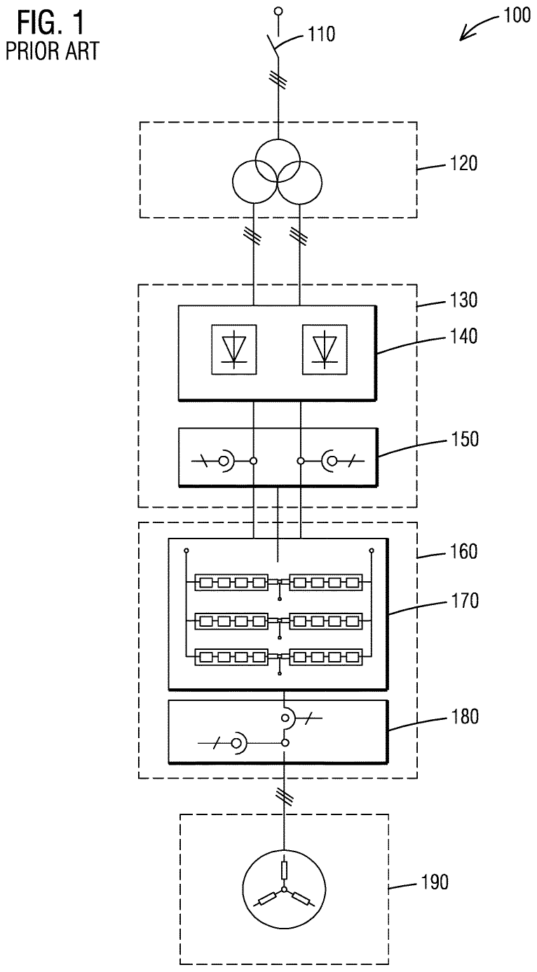

FIG. 1 illustrates a schematic of a basic configuration of a modular multilevel converter system 100 in accordance with an exemplary embodiment described herein. In an example, the converter system 100 comprises a basic input module 130 and an output module 160 deploying M2C or M2LC technology. The basic input module 130 generates a DC voltage and provides energy for the output module 160 connected to the basic input module 130. In an example, the basic input module 130 can comprise series-connected six-pulse rectifiers 140. The output module 160 provides power for a connected motor 190, which can be for example a high voltage AC motor. The output module 160 is supplied with power for the motor 190 via the basic input module 130, which represents a DC link. The output module 160 comprises an inverter unit 170 with M2C or M2LC technology comprising multiple semiconductors, in particular Insulated Gate Bipolar Transistors (IGBTs). The output module 160 including M2C or M2LC subsystems, herein also referred to as power cells, provides the motor 190 with almost sinusoidal voltages. In an example, the inverter 170 can comprises three phases. Each phase comprises two so-called M2C or M2LC branches. The six branches of the inverter 170 each consist of identical subsystems (power cells) connected in series.

FIG. 1 further illustrates a circuit-breaker 110 and transformer 120 as an example for a power supply for the converter system 100. Furthermore, the converter system 100 can comprise one or more measuring units 150, 180 used to measure voltages and currents. For example, measuring unit 150 measures voltages and currents of the basic line module 130, and measuring unit 180 measures voltages and currents on the motor side. Voltages can be measured using AVT (actual value transmission) combination modules, currents can be measured using electronic current transformers and AVT combination modules. The AVT combination modules convert analog signals into digital signals and transfer the signals to a control unit for example via fiber-optic cables. It should be noted that the converter system 100 of FIG. 1 may comprise more components, such as for example control module(s), cooling module(s), braking module(s) and/or bypass module(s). Control module(s) are typically used for open-loop and closed-loop control of the drive as well as operating control and diagnostics of the drive.

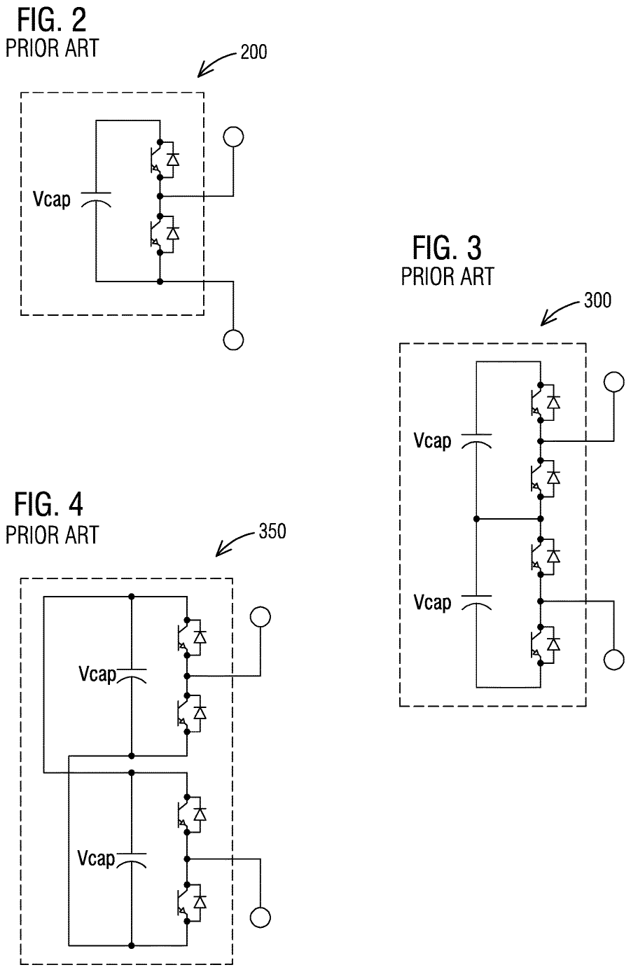

FIG. 2 illustrates a known two-level configuration of an M2LC subsystem 200 having two terminals, and FIG. 3 and FIG. 4 illustrate known three-level configurations of an M2LC subsystem 300 an M2LC subsystem 350 having two terminals.

As shown in FIG. 2, the M2LC subsystem 200 includes two switching devices, two diodes, a capacitor and two terminals. The two switching devices can be controlled such that one of two different potentials (e.g., zero volts or Vcap) may be present across the two terminals. As shown in FIG. 3 and FIG. 4, the M2LC subsystems 300, 350 include four switching devices, four diodes, two capacitors and two terminals, wherein the four switching devices can be controlled such that one of three different potentials (e.g., zero volts, Vcap or 2Vcap) may be present across the two terminals. Note that three levels can also be produced with the same number of switching devices and capacitors by parallel arrangement as shown in FIG. 4, where the output voltage is zero volts, +Vcap and −Vcap. Arrangements such as shown in FIG. 4 are traditionally known as Cascaded H-Bridge. Although other topologies of the M2LC subsystems 200, 300, 350 are possible, all of the topologies may be defined as two-terminal subsystems or power cells with internal capacitor energy storage(s) which are capable of producing various levels of voltages between the two terminals depending on the state of the switching devices.

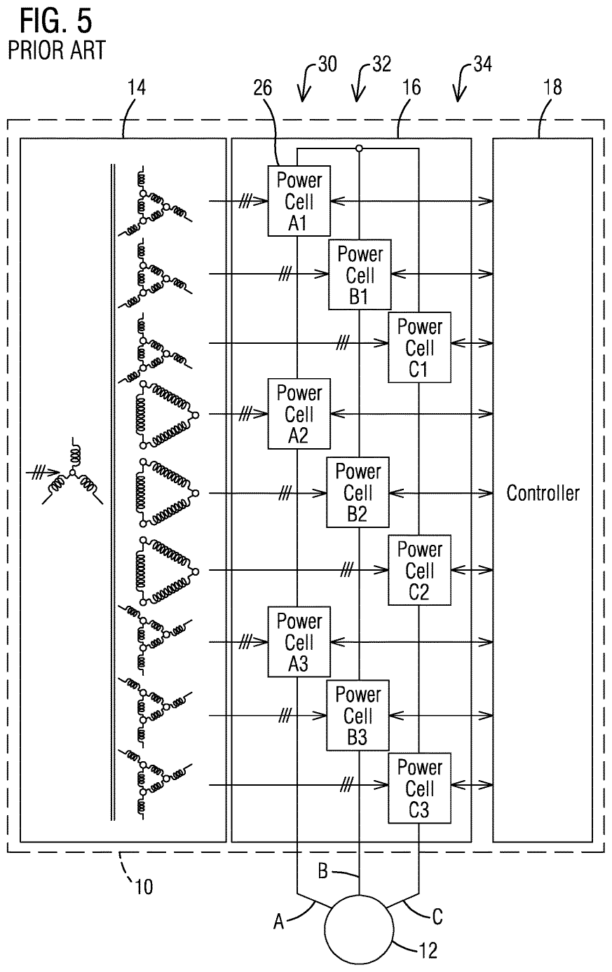

FIG. 5 illustrates a schematic diagram of a known basic configuration of a cascaded H-bridge converter system in accordance with an exemplary embodiment described herein.

Multi-cell power supply 10 receives three-phase power from an alternating current (AC) source, and delivers power to a load 12, e.g., a three-phase AC motor. The load 12 may comprise an AC-type motor, for example, synchronous, asynchronous, permanent magnet, and may be rated for low voltage, medium voltage or high voltage. For example, medium-voltage AC motors, such as those used in industrial process control, may operate in the 4.16 kV to 13.8 kV range. Greater or lesser voltage may be used. More than one motor may be connected. Other loads may be used instead of or in addition to the motor. The motor responds to voltage applied by the multi-cell power supply 10 on the three phases, for example, to increase, decrease or maintain a speed or position.

The multi-cell power supply 10 includes a transformer 14, a power circuit 16, and a central control system 18, herein also referred to as controller. The transformer 14 includes a primary winding that excites nine secondary windings, and the power circuit 16 includes multiple printed circuit board (PCB) power cells 26, herein simply referred to as power cells 26 or as power modules, that are operably coupled to the secondary windings, respectively, of the transformer 14. As the power supply 10 comprises nine secondary windings, and a power cell 26 is operably coupled to each secondary winding, the power supply 10 comprises nine power cells 26. Of course, the power supply 10 can comprise more or less than nine power cells 26 and/or more or less than nine secondary windings depending on a type of the power supply 10 and/or a type of the load 12 coupled to the power supply 10. The power cells 26 are configured to provide a medium voltage output to the load 12. Each output phase A, B, C of the power circuit 16 is fed by a group of series connected power cells 26. Outputs of the power cells 26 are coupled in series in a first phase group 30, at second phase group 32, and a third phase group 34. Each phase output voltage is a sum of the output voltages of the power cells 26 in the respective phase group 30, 32 and 34. For example, the first phase group 30 comprises power cells 26 labelled A1, A2 and A3, wherein the phase output voltage of the output phase A is the sum of the output voltages of the power cells A1, A2 and A3. The same applies to output phase B and power cells B1, B2, B3, and output phase C and power cells C1, C2, C3. In this regard, the power circuit 16 delivers a medium voltage output to output load 12 using lower voltage rated power cells 26 that include components rated to lower voltage standards.

Each power cell 26 is coupled, e.g., for example via an optical fiber communication link, to central control system 18, which may use current feedback and voltage feedback to control operation of the power cells 26.

It should be noted that in FIG. 1 the number of power cells 26, in each phase group 30, 32, 34 can be between 2 and 12 to provide different (medium voltage) outputs as required by the load 12. As noted in the embodiment of FIG. 1, the number of secondary windings of transformer 14 matches the number of power cells 26. It will be appreciated by those of ordinary skill in the art that other cell counts, and diode bridge counts may be used depending upon the application and that the configurations shown and described herein are intended to be exemplary in natures.

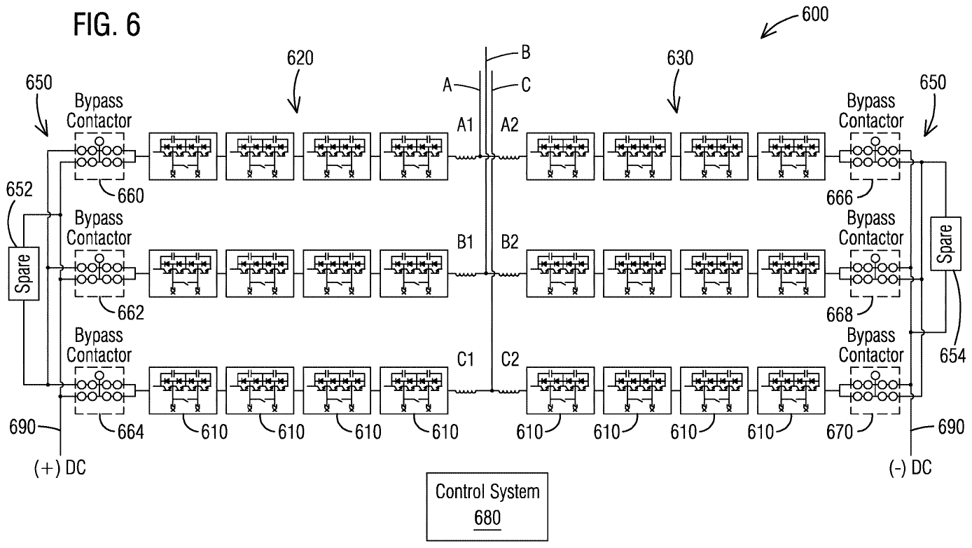

FIG. 6 illustrates a schematic diagram of a first embodiment of a modular multilevel converter system having a plurality of M2C or M2LC subsystems and including cell bypass in accordance with an exemplary embodiment of the present disclosure. More specifically, FIG. 6 illustrates a schematic diagram of a power circuit 600, herein also referred to as inverter 600 (see also inverter unit 170 in FIG. 1) including improved cell bypass.

The inverter 600 comprises M2C or M2LC subsystems 610, herein also referred to as power cells 610, including semiconductors, in particular Insulated Gate Bipolar Transistors (IGBTs). In an example, the inverter 600 comprises three phases A, B and C. Each phase A, B and C comprises two so-called M2C or M2LC branches or arms A1, A2, B1, B2, C1 and C2. The six branches/arms A1, A2, B1, B2, C1, C2 each consist of identical subsystems (power cells) connected in series. The branches A1, B1, C1 are referred to as an upper arm phase group 620, and the branches A2, B2, C2 are referred to as a lower arm phase group 630. The example of FIG. 6 includes 24 power cells 610, 12 power cells 610 in the upper arm phase group 620 and 12 power cells in the lower arm phase group 630. However, it should be noted that the power circuit 600 may comprise more or fewer than the illustrated power cells 610. For example, the power circuit 600 may comprise 18 power cells (9 cells per arm) or 30 power cells (15 cells per arm).

As described earlier, known cell bypass systems require that a spare (redundant) power cell is installed in each output phase arm (upper and lower), for example due to fixed output phase (voltage) reference.

In accordance with an exemplary embodiment of the present disclosure, the converter system, specifically the power circuit (inverter) 600, comprises a bypass mechanism 650 comprising spare power cells and bypass contactors, wherein by use of the bypass contactors (switches), a single spare power cell can be installed at a point of common coupling and switched into any output phase as needed, thereby providing redundancy for the power cells 610.

The embodiment of FIG. 6 illustrates an N+1 redundancy cell bypass, which means that a single spare power cell 652 is provided for the upper arm phase group 620 and a single spare power cell 654 is provided for the lower arm phase group.

The branches A1, B1, C1 of the upper arm phase group 620 are connected at a first point of common coupling, and the first spare power cell 652 is installed at the first point of common coupling. The branches A2, B2, C2 of the lower arm phase group 630 are connected at a second point of common coupling, and the second spare power cell 654 is installed at the second point of common coupling.

The bypass mechanism 650 further comprises bypass contactors, wherein a bypass contactor is arranged for each upper arm branch A1, B1, C1 and each lower arm branch A2, B2, C2. Specifically, bypass contactor 660 is coupled between spare power cell 652 and branch A1, bypass contactor 662 is coupled between spare power cell 652 and branch B1 and bypass contactor 664 is coupled between spare power cell 652 and branch C1. On the other hand, bypass contactor 666 is coupled between spare power cell 654 and branch A2, bypass contactor 668 is coupled between spare power cell 654 and branch B2 and bypass contactor 670 is coupled between spare power cell 654 and branch C2.

In exemplary embodiments, the bypass contactors comprise semiconductor switches, or mechanical switches, or pyro switches or a combination thereof.

In an embodiment, the upper arm branches A1, B1, Cl are connected by a WYE connection, wherein the first spare power cell 652 is installed at the ‘Y’ (neutral) of the WYE connection. The lower arm branches A2, B2, C2 are connected by a WYE connection, and wherein the second spare power cell 654 is installed at the ‘Y’ (neutral) of the connection. The spare power cells 652, 654 can be installed at positive (+) or negative (−) bus of the common coupling.

In an embodiment, the drive system comprises a control system 680 that is configured to control the bypass contactors 660, 662, 664 such that the first spare power cell 652 is switched into any of the upper arm branches A1, B1, C1 in response to a failed power cell in any of the upper arm branches A1, B1, C1 and to control the bypass contactors 666, 668, 670 such that the second spare power cell 654 is switched into any of the lower arm branches A2, B2, C2 in response to a failed power cell in any of the lower arm branches A2, B2, C2.

A voltage source power supply comprises a common DC link 690, wherein the power cells 610 including the spare power cells 652, 654 and the bypass contactors 660, 662, 664, 666, 668, 670 are supplied with voltage from the common DC link 690.

The installation of a single spare power cell 652, 654 per each phase group (upper arm phase group 620 and lower arm phase group 630) provides significant cost savings by:
reducing the spare power cell count from six to two (N+1 redundancy),
reducing the overall drive system footprint, reducing the drive system cooling requirement, and
reducing the drive system complexity (wiring, fibers etc.).

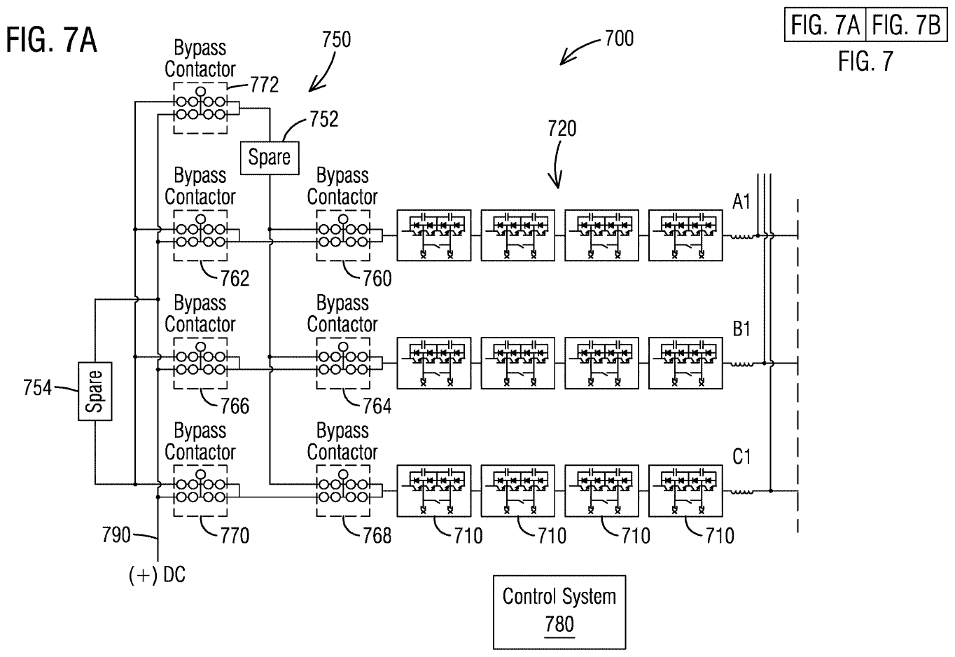

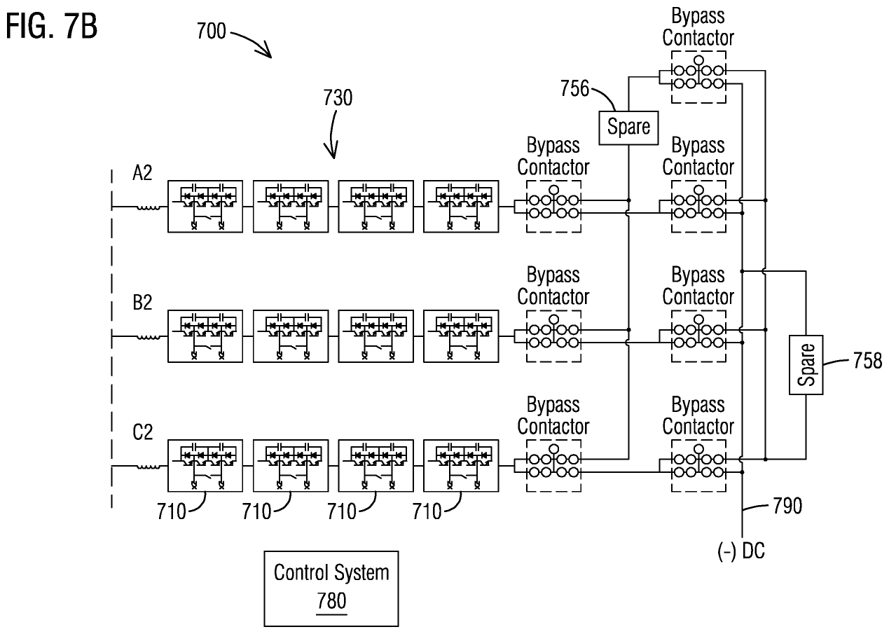

An installation of two spare power cells (N+2 redundancy) per each phase group, as described with reference to FIG. 7, adds the ability to bypass two cells in one or more output phases, which is an enhanced functionality of the system. Further, installation of more spare power cells (N+3 redundancy, N+4 redundancy etc.) is possible.

FIG. 7 illustrates a schematic diagram of a second embodiment of a modular multilevel converter system having a plurality of M2C or M2LC subsystems and including cell bypass in accordance with an exemplary embodiment of the present disclosure. More specifically, FIG. 7 illustrates a schematic diagram of a power circuit or inverter 700 including improved cell bypass.

The embodiment of FIG. 6 illustrates an N+1 redundancy cell bypass, whereas FIG. 7 illustrates a N+2 redundancy cell bypass. For a N+2 cell bypass, two spare power cells are provided for the upper arm phase group and two spare power cells are provided for the lower arm phase group.

More specifically, the power circuit 700 comprises M2C or M2LC subsystems 710, herein also referred to as power cells 710, including semiconductors, in particular Insulated Gate Bipolar Transistors (IGBTs). The power circuit 700 comprises three phases A, B and C. Each phase A, B and C comprises two so-called M2C or M2LC branches or arms A1, A2, B1, B2, C1 and C2. The six branches/arms A1, A2, B1, B2, C1, C2 each consist of identical subsystems (power cells) connected in series. The branches A1, B1, C1 are referred to as an upper arm phase group 720, and the branches A2, B2, C2 are referred to as a lower arm phase group 730.

Bypass mechanism 750 comprising spare power cells and bypass contactors, wherein by use of the bypass contactors (switches), the spare (redundant) power cells can be installed at a point of common coupling and switched into any output phase as needed, thereby providing redundancy for the power cells.

As noted, the embodiment of FIG. 7 illustrates a N+2 redundancy cell bypass, which means that two spare (redundant) power cells 752 and 754 are provided for the upper arm phase group 720 and two power cells 756 and 758 are provided for the lower arm phase group 730.

The bypass mechanism 750 further comprises bypass contactors, wherein, due the N+2 redundancy, two bypass contactors are arranged for each branch A1, B1, C1 of upper arm phase group 720 and two bypass contactors are arranged for each branch A2, B2, C2 of lower arm phase group 730.

Specifically, bypass contactors 760, 762 are coupled between spare power cells 752, 754 and branch A1, bypass contactors 764, 766 are coupled between spare power cells 752, 754 and branch B1 and bypass contactors 768, 770 are coupled between spare power cells 752, 754 and branch C1. Further, since we have two spare power cells 752, 754 on each arm, an additional bypass contactor 772 is provided. The same concept applies to the lower arm phase group 730 with two spare power cells 756, 758 and seven bypass contactors. In exemplary embodiments, the bypass contactors comprise semiconductor switches, or mechanical switches, or pyro switches or a combination thereof.

Further, a control system 780 is configured to control the bypass contactors 760-772 of the upper arm phase group 720 as well as the bypass contactors of the lower arm phase group 730 such that the first spare power cell 752, and if necessary the second power cell 754, is switched into any of the upper arm branches A1, B1, C1 in response to a failed power cell in any of the upper arm branches A1, B1, C1 and to control the bypass contactors such that the third spare power cell 756, and if necessary the fourth spare power cell 758, is switched into any of the lower arm branches A2, B2, C2 in response to a failed power cell in any of the lower arm branches A2, B2, C2.

A voltage source power supply comprises a common DC link 790, wherein the power cells 710 including the spare power cells 752, 754, 756, 758 and the bypass contactors are supplied with voltage from the common DC link 790.

With respect to the embodiments of FIG. 6 and FIG. 7 (bypass mechanism for modular multilevel converter), the power circuit (inverter) 600, 700 may be operated according to different control philosophies, utilizing control system 680, 780. With reference to FIG. 6, according to a first control philosophy, the spare power cells 652, 654 are out of the circuit under normal conditions. When a cell failure occurs, the spare cell 652, 654 is inserted into the output phase where the failure occurred via the respective bypass contactor. According to a second control philosophy, the spare cells 652, 654 are part of the inverter circuit under normal conditions and can be used for example to charge capacitors. When a failure occurs, the spare cell is inserted into the output phase where the failure occurred via the respective bypass contactor. These control philosophies may be also applied to the embodiment of FIG. 7 (N+2 redundancy).

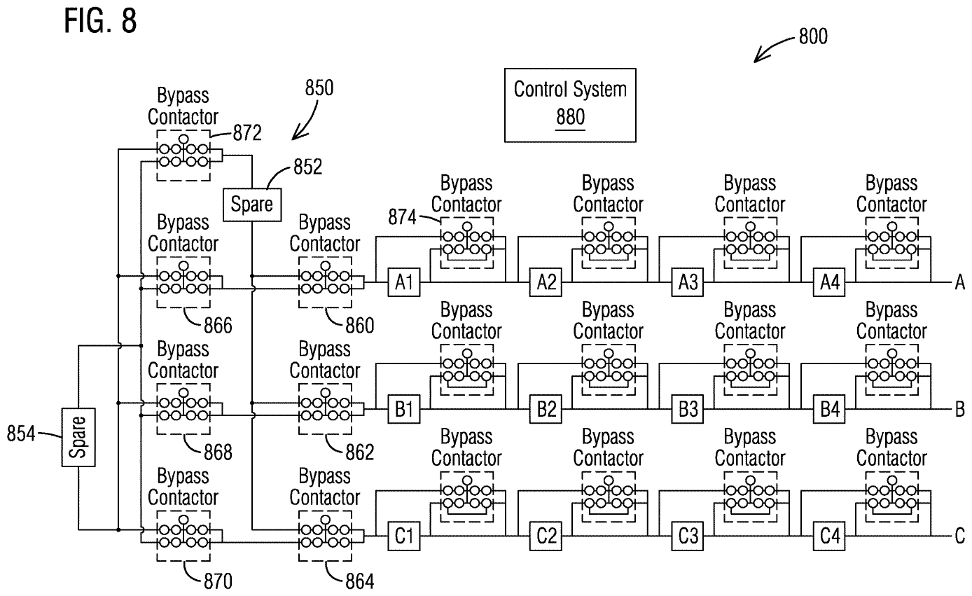

FIG. 8 illustrates a schematic diagram of an embodiment of a cascaded H-bridge converter system including cell bypass in accordance with an exemplary embodiment of the present disclosure.

More specifically, FIG. 8 illustrates a power circuit 800, herein also referred to as inverter 800, including multiple power cells, for example PCB power cells. Each output phase A, B, C of the power circuit 800 is fed by a group of series connected power cells. For example, output phase A comprises power cells A1, A2, A3 and A4, wherein the phase output voltage of the output phase A is the sum of the output voltages of the power cells A1, A2, A3 and A4. The same applies to output phase B and power cells B1, B2, B3, B4 and output phase C and power cells C1, C2, C3, C4.

Each power cell is coupled, e.g., for example via an optical fiber communication link, to central control system 880, which may use current feedback and voltage feedback to control operation of the power cells. The control system 880 is further configured to control bypass mechanism 850.

In accordance with an exemplary embodiment of the present disclosure, the power circuit includes a N+2 redundancy bypass mechanism 850. Two spare power cells 852, 854 are installed such that each spare power cell 852, 854 can be switched/inserted into the output phase A, B or C where the failure occurred. Bypass contactors 860, 862, 864 are coupled between first spare power cell 852 and phases A, B and C, respectively, and bypass contactors 866, 868, 870 are coupled between second spare power cell 854 and phases A, B, C, respectively. Further, bypass contactor 872 is arranged between the two spare power cells 852, 854.

Since the power cells A1-A4, B1-B4 and C1-C4 of the cascaded H-bridge converter are independently supplied from isolated voltage sources or secondary windings, additional bypass contactors are assigned to each power cell. For example, bypass contactor 874 is assigned to and coupled with power cell A1. When power cell Al fails, bypass contactor 874 and bypass contactor 860 are closed to insert spare power cell 852.

The described power circuits 600, 700 and 800 including cell bypass provide the following advantages:
N+1 redundancy is achieved with a minimum number of spare cells.
The spare cell is added to the output phase where cell failure occurred.
The control system does not have to adapt to an unbalanced set of cells (as in the traditional method), i.e., neutral shift is not required.

There are cost savings because only one spare cell for each half of the topology in the modular multilevel converter (FIG. 6), and one cell for a cascaded H-bridge converter are required.
The cell bypass mechanism can be easily extended to provide N+2 redundancy,
Further, the proposed systems and methods can be applied to modular multilevel converters (MMC) and cascaded H-bridge converters (CHB) converters using other cell types, such as twin cell and H-bridge (for the MMC), and NPC (for the CHB).

1.-20. (canceled)

21. A drive system, comprising:
a power circuit comprising a plurality of power cells supplying power to output phases, each output phase comprising a phase group of series-connected power cells;
a voltage source power supply; and
a bypass mechanism comprising spare power cells and bypass contactors,
wherein the phase groups of the power circuit are connected at a point of common coupling, and
wherein a spare power cell is installed at the point of common coupling.

22. The drive system of claim 21, wherein the power circuit with the plurality of power cells are configured as M2C or M2CL subsystems.

23. The drive system of claim 21, wherein each output phase comprises an upper arm phase group and a lower arm phase group, wherein the upper arm phase groups are connected at a first point of common coupling, wherein the lower arm phase groups are connected at a second point of common coupling, and wherein a first spare power cell is installed at the first point of common coupling and a second spare power cell is installed at the second point of common coupling.

24. The drive system of claim 23, wherein the bypass contactors comprise a bypass contactor for each upper arm phase group and a bypass contactor for each lower arm phase group.

25. The drive system of claim 23, further comprising a control system configured to
control the bypass contactors such that the first spare power cell is switched into any of the upper arm phase groups in response to a failed power cell in any of the upper arm phase groups, and
control the bypass contactors such that the second spare power cell is switched into any of the lower arm phase groups in response to a failed power cell in any of the lower arm phase groups.

26. The drive system of claim 23. wherein the upper arm phase groups are connected by a WYE connection, and wherein the first spare power cell is installed at the ‘Y’ (neutral) of the WYE connection.

27. The drive system of claim 23, wherein the lower arm phase groups are connected by a WYE connection, and wherein the second spare power cell is installed at the ‘Y’ (neutral) of the connection.

28. The drive system of claim 21, wherein the voltage source power supply comprises a common DC link, and wherein the plurality of power cells, the spare power cells and the bypass contactors are supplied from the common DC link.

29. The drive system of claim 21, wherein the spare power cells are installed at a positive or negative bus of the common coupling.

30. The drive system of claim 21, wherein the bypass contactors comprise semiconductor switches, or mechanical switches, or pyro switches or a combination thereof.

31. The drive system of claim 23, wherein two of the spare power cells are installed for the upper arm phase group and the lower arm phase group, respectively.

32. The drive system of claim 21, wherein the power circuit with the plurality of power cells are configured cascaded H-bridge subsystems.

33. The drive system of claim 32, wherein a first spare power cell and a second spare power cell are installed at the point of common coupling.

34. The drive system of claim 32, wherein at least one bypass contactor is installed for each output phase, and wherein further bypass contactors are assigned and installed for each individual power cell.

35. The drive system of claim 33, further comprising a control system configured to
control the bypass contactors such that the first spare power cell is switched into any of the phase groups in response to a failed power cell in any of the phase groups, and
control the bypass contactors such that the second spare power cell is switched into any of the phase groups in response to a failed power cell in any of the phase groups.

36. The drive system of claim 33, wherein the point of common coupling comprises a WYE connection, and wherein the first and/or second spare power cell is installed at the ‘Y’ (neutral) of the WYE connection.

37. The drive system of claim 32, wherein the bypass contactors comprise semiconductor switches, or mechanical switches, or pyro switches or a combination thereof.

38. A medium voltage variable frequency drive, comprising a power circuit, the power circuit comprising a plurality of power cells supplying power to output phases, each output phase comprising a phase group of series-connected power cells.

39. The medium voltage variable frequency drive of claim 38, wherein the power circuit with the plurality of power cells is configured as M2C or M2CL subsystems.

40. The medium voltage variable frequency drive of claim 38, wherein the power circuit with the plurality of power cells is configured as cascaded H-bridge subsystems.
